(19) United States
(12) Patent Application Publication
(10) Pub. No.: US 2020/0201356 A1
(43) Pub. Date: Jun. 25, 2020

(54) SYSTEMS AND METHODS FOR MANAGING PLATOONING BEHAVIOR

(71) Applicant: Peloton Technology, Inc., Mountain View, CA (US)

(72) Inventors: Austin B. Schuh, Los Altos, CA (US); Stephen M. Erlien, Mountain View, CA (US); Joshua P. Switkes, Mountain View, CA (US); James Kuszmaul, San Mateo, CA (US); Carlos J. Rosario, San Jose, CA (US)

(73) Assignee: Peloton Technology, Inc., Mountain View, CA (US)

(21) Appl. No.: 16/230,962

(22) Filed: Dec. 21, 2018

(51) Int. Cl. G05D 1/02; G05D 1/00; B60T 7/12; B60T 8/171; B60T 8/17

(52) U.S. Cl. CPC G05D 1/0293; G05D 1/0088; B60T 7/12; G05D 2201/0213; B60T 8/17; G05D 1/028; B60T 8/171

(57) ABSTRACT

Systems and methods for managing platooning vehicles are described herein. In one aspect, a first vehicle may transmit information to a second vehicle indicating one or more conditions, such as an amount of brake applied at the first vehicle. Based on the condition received at a controller in the second vehicle, the controller in the second vehicle may adjust how it operates. For example, the controller in the second vehicle may adjust how much emphasis it places on one type of input as opposed to another.

### BACKGROUND

Enabling a vehicle to follow closely behind one vehicle safely through partial or full automation has significant fuel savings, safety, and/or labor savings benefits, but is generally unsafe when a driver tries to do this manually. Presently, during normal driving, vehicle motion is controlled either manually, by a driver, or by convenience systems, such as cruise control or adaptive cruise control. The various types of cruise control systems control vehicle speed to make driving more pleasurable or relaxing, by partially automating the driving task. Some of these systems use range sensors and/or vehicle sensors to control the speed to maintain a constant headway relative to the leading vehicle (also referred to herein as a front vehicle). In general, these cruise control systems provide minimal added safety, and do not have full control of the vehicle (in terms of being able to fully brake or accelerate).

Driver control does not match the safety performance of even current systems, for several reasons. First, a driver cannot safely maintain a close following distance. In fact, the relatively short distances between vehicles necessary to get any measurable fuel savings results in an unsafe condition if the vehicle is under driver control, thereby risking a costly and destructive accident. Further, the driver is not as capable of maintaining an optimal headway as an automated system is. In fact, a driver trying to maintain a constant headway often causes rapid and large changes in command (accelerator pedal position for example), resulting in a loss of efficiency.

Thus, it would be desirable to have reliable and economical at least semi-automated vehicular convoying/platooning systems which enable vehicles to follow closely together in safe, efficient, and convenient manner.

Moreover, it is important to provide users with a pleasant user experience, particularly because drivers may not favor using the methods and systems described herein if they do not enjoy using them. As such, systems that do not cause unnecessary faults or harsh braking are needed in the art.

### SUMMARY

The systems and methods comprising various aspects of the disclosure described herein provide for more efficient management of multiple vehicles. For example, without limitation, aspects of the present invention establish a wireless communication link between a first vehicle and a second vehicle. The first vehicle and the second vehicle may platoon based at least in part on information transmitted over the wireless communication link. The first vehicle may detect at one or more of its sensors a condition, such as an amount of brake applied. In response to the one or more detected conditions, a platoon electronic controller (PECU) may place more or less weight on one or more received signals.

Additional methods and systems described herein may provide for instructions that cause a processor in a platooning control unit (PECU) to receive a transmission from a front vehicle including a detected condition. Based on this detected condition, a controller within a PECU may be configured to perform in one of a plurality of ways.

Further, methods and systems described herein may manage a platoon of vehicles by receiving information about an amount of brake applied at a front vehicle. Based on the amount of brake applied at the front vehicle being above a threshold amount, a controller may weight signals intended to cause a hard brake more than signals intended to cause a light brake.

It will be appreciated by those skilled in the art that the various features of the present disclosure can be practiced alone or in combination.

These and other features of the present disclosure will be described in more detail below in the detailed description of the disclosure and in conjunction with the following figures.

### BRIEF DESCRIPTION OF THE DRAWINGS

In order to describe the various aspects of the present disclosure, some detailed description now will be provided, by way of illustration, with reference to the accompanying drawings, in which:

FIG. 1 illustrates a diagram of a platooning system, in accordance with some embodiments;

FIG. 2 illustrates a block diagram of a platooning system, in accordance with some embodiments;

FIG. 3 illustrates a block diagram of a system including an electronic control unit, in accordance with some embodiments;

FIG. 4 illustrates block diagram of a system including a platoon electronic control unit, in accordance with some embodiments;

FIG. 5 illustrates a graph, in accordance with some embodiments;

FIG. 6 illustrates an example flowchart, in accordance with some embodiments; and

FIG. 7 illustrates an example computing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practiced without implementing all of the features disclosed herein. Further, although many embodiments included in the instant application are related to the concept of platooning, it should be appreciated that many broader applications are envisioned.

Without limitation, the Applicant has proposed various vehicle platooning systems in which a second, and potentially additional, vehicle(s) is/are automatically, or semi-automatically controlled to closely follow a lead/front vehicle in a safe manner. By way of example, U.S. patent application Ser. Nos. 15/605,456, 15/607,902; 13/542,622 and 13/542,627; U.S. Provisional Patent Application Nos. 61/505,076, 62/377,970 and 62/343,819; and PCT Patent Application Nos. PCT/US2014/030770, PCT/US2016/049143, PCT/US2018/41684, and PCT/US2016/060167 describe various vehicle platooning systems in which a trailing vehicle (also referred to herein as a rear vehicle) is at least partially automatically controlled to closely follow a designated lead vehicle. Each of these earlier applications are incorporated herein by reference.

One of the goals of platooning is typically to maintain a desired position between the platooning vehicles and/or a desired relative speed and/or time headway (e.g., a gap may refer to a distance, a headway, or both). Thus, it should be appreciated that, herein, any reference to the term “gap” could refer to a distance, a headway, or both. Further, while the term “maintain” is used throughout this disclosure, maintaining may mean staying within a gap (distance/headway), staying at a gap, and/or keeping at least a certain gap. Further, a desired gap may include a relative distance, time headway, and/or angle/offset. A longitudinal distance and/or time headway is frequently referred to herein as a “target gap”. That is, it is desirable for the trailing vehicle (e.g., a rear vehicle) to maintain a designated gap relative to a specific vehicle (e.g., a lead vehicle). The vehicles involved in a platoon will typically have sophisticated control systems suitable for initiating a platoon, maintaining the gap under a wide variety of different driving conditions, and gracefully dissolving (e.g., ending) the platoon as appropriate. It should be appreciated that herein, a gap may refer to a distance, a time headway, or either.

As described herein, the concept of platooning, also known as convoying, is still in its infancy. Academics have toyed with the concept over the last few decades, but to date there are no commercial systems on the road where a vehicle is at least partially controlled by another vehicle via vehicle-to-vehicle (V2V) communication (which may be referred to as platooning). The benefits provided by such systems are obvious. Namely, the safety provided by these systems is far greater than a system where a rear vehicle doesn't begin to slow down until its radar or LIDAR sensors determine that a lead vehicle is slowing down, such as with some adaptive cruise control systems. Further, by being able to follow another vehicle at a close distance, in some cases both a rear vehicle and a front vehicle may experience significant fuel savings.

As platoonable vehicles (e.g., vehicles capable of platooning) begin to roll out of the labs and into commercial production, their adoption faces significant challenges. For example, in some embodiments, when an action is performed by a front vehicle in response to various external factors, a rear vehicle may want to perform the same and/or similar actions, while at the same time providing a pleasant and safe experience for the rear driver.

In some embodiments, information sent from one vehicle to another may change one or more aspects of a controller, such as controller gains, observer gains, modes, and/or other behaviors. Of course, commanding and/or controlling torque is one example, but there are many other examples. In some embodiments, if a front vehicle brakes hard, then a controller may change its normal behavior such that it responds more aggressively and/or rapidly to hard braking than to soft braking.

In various embodiments described herein, hard braking (also referred to as a hard brake event) may refer to pressing a brake pedal hard (e.g., above a threshold amount of force), and soft braking (also referred to as a soft brake event) may refer to pressing a brake pedal softly (e.g., below a threshold amount of force). Brake force may correspond with a hard braking event and/or a soft braking event, and: be applied by a driver's foot, be applied by an actuator, operated wirelessly, be part of a drive-by-X-system, etc. As described herein, hard braking may occur at a front vehicle and cause (e.g., via a wireless transmission) a rear vehicle to perform a hard braking event (“performing a hard braking event” may also be referred to as brake/braking hard). Similarly, soft braking may occur at a front vehicle and cause (e.g., via a wireless transmission) a rear vehicle to perform a soft braking event (“performing a soft braking event” may also be referred to as brake/braking soft).

In some embodiments, whether a hard braking event is occurring may be determined (e.g., at a NOC, front, and/or rear vehicle) by: an estimator, a sensor, information associated with a valve, information associated with a transmission, information associated with a CVT, information associated with an engine, information associated with a retarder, an amount of pressure (e.g., brake pressure (which may include brake fluid pressure) (e.g., an amount of pressure above a threshold amount), an amount of deceleration (e.g., an amount of deceleration above a threshold amount), etc. In some embodiments, whether a soft braking event is occurring may be determined (e.g., at a NOC, front, and/or rear vehicle): by an estimator, a sensor, information associated with a valve, information associated with a transmission, information associated with a CVT, information associated with an engine, information associated with a retarder, an amount of pressure (e.g., brake pressure (which may include brake fluid pressure)) (e.g., an amount of brake pressure below a threshold amount), an amount of deceleration (e.g., an amount of deceleration below a threshold amount,), etc.

In some embodiments, a NOC, rear, and/or front vehicle may perform actions based on a hard brake and/or soft brake at a rear and/or front vehicle, including at least one of: adjusting a controller (e.g., any type of electronic control unit, including an electronic engine control unit (EECU, also referred to as an engine control unit, or a PECU)), adjusting an amount of gain, adjusting a filter, adjusting an estimator, adjusting a transmission, adjusting an engine and/or motor, adjusting a braking system, causing a camera to record, causing a system to store an amount of video (e.g., video stored in a buffer), transmitting information associated with the hard brake and/or soft brake, etc.

In some embodiments, a hard braking event may correspond to information associated with a valve, information associated with a transmission, information associated with a CVT, information associated with an engine, information associated with a retarder, an amount of pressure (e.g., brake pressure (which may include brake fluid pressure), an amount of deceleration, etc.). In some embodiments, a soft braking event may correspond to information associated with a valve, information associated with a transmission, information associated with a CVT, information associated with an engine, information associated with a retarder, an amount of pressure (e.g., brake pressure (which may include brake fluid pressure), an amount of deceleration, etc.).

In some embodiments, differences in a gain, a different type of controller, a weighting factor, a velocity, a type of brakes, or other factors may contribute to the behavior of one or more platoon controllers (PECUs, also referred to as platoon electronic control units, and/or platooning electronic control units). As another example, if lane keeping assistance was performed in one method by a controller, that method may change in response to attributes of a vehicle and/or attributes of a lane (e.g., width). In such a case, for example, the method may change such that a rear vehicle follows at a different distance.

Returning to modifying the aspects of a controller (e.g., changing the behavior of a controller) based on a level of braking, in some embodiments, inputs are treated differently based on a level of braking in a front vehicle. For example, if a front vehicle brakes hard, a controller may cause the back vehicle to brake hard, and not consider (e.g., at all, as much) slight variations in an amount of brakes applied as it does when front truck engages in light braking (e.g., not hard braking).

In other words, a one size fits all solution—with regard to various aspects of controller functions—may not always work well.

In some cases a tradeoff between the amount smoothness caused by a braking event, and an amount of safety caused by a braking event (e.g., safety caused by a hard brake) may be determined apriori (e.g., in some embodiments, before the current platooning session, before a brake, before a sensor determines a brake must/will occur, etc.) and provide for a ride that is either not as smooth, or not as safe.

In some embodiments, described herein there is a tradeoff that an ECU and/or controller may be programmed to make wherein the tradeoff is dynamically chosen to “get the best of both worlds”—for example, allowing a vehicle to provide a smooth stop or a safer/harder stop in real- or near-real time.

In the braking example, when light braking is applied at a front vehicle there may be fluctuations or slight variations in an amount of braking applied (e.g., with foundation brakes). For example, a driver may apply light braking, but their foot may press harder, then softer, then harder, then softer, etc. Further, abrupt fluctuations may occur at a rear vehicle because different levels of braking that may seem slight to a front driver may be more pronounced at a rear vehicle in response to a PECU/BECU translating braking signals while accounting for different vehicle masses, different braking system attributes, etc. Fluctuations may also be caused by data transmission issues such as packet loss, noise, corrupt information, etc. In response, ins some embodiments, to avoid these fluctuations being propagated to a rear vehicle's PECU and/or a rear vehicle's brake electronic controller (BECU), a filter may be applied to one or more signals associated with braking such that the brake applied at the rear vehicle is smoother than the brake applied by the driver of the front vehicle. In various embodiments, one or more controllers may be tuned to optimize the smoothness of light braking (e.g., at a rear vehicle, such that a driver is comfortable) based on information/data/transmissions from a front vehicle (e.g., a car or truck).

However, in cases of hard braking (which may be safety critical), a system may not care as much about smoothing braking, since it wants the rear vehicle to apply hard braking also. In other words, in response to hard braking (e.g., above a threshold), a controller may not place as much weight on filtering braking signals. In such a case, a controller may place more weight on the acceleration (e.g., the negative acceleration) and/or an amount of brakes applied on a front vehicle. Thus, in various embodiments, based on an amount of braking applied on a front vehicle, a model may be applied that dictates how a controller operates (e.g., whether it anticipates light braking and applies filters (such as a Kalman filter) to smooth fluctuations in amounts of braking, or whether it anticipates hard braking and makes hard braking a higher priority than smoothing fluctuations). In some embodiments, a determination of a particular model to apply may be made at least in part by a PECU receiving measurements from an internal measurement unit (IMU).

In some embodiments, an amount of pressure applied to a brake pedal (or other portion of a system that can be read using a sensor) may be classified to determine whether to change the functionality of a controller. For example, if light braking is sensed, the controller may apply filtering to account for small fluctuations, but if hard braking is sensed, the controller may change modes and reduce an amount of filter applied (e.g., because the controller does not care about smoothness in a hard-braking event). In addition to applying a certain amount of filter to an amount of braking, filters may be applied to signals corresponding to perception (e.g., camera, radar, LIDAR), data about a front vehicle's location and speed, etc. Signals such as these may experience noise, and as such heavy filtering may be applied to provide a smooth response/experience (e.g., an amount of braking in response to an object detected by a camera, wherein the information from the camera is filtered heavily), but in some cases less filtering is required to increase safety, which may create a harsher/less smooth experience.

In some embodiments, one or more models may be created and/or used to determine an action to take (e.g., determine how a controller functions). For example, during hard braking a model may be relied on heavily, while during light braking a model may not be relied on as heavily (or vice-versa). In some embodiments, in response to a front driver braking, a signal is sent to a rear vehicle (e.g., via DSRC) indicating the pressures that are created on brake lines when the brake pedal is applied in the front vehicle. These pressures may map to forces generated at wheels of a vehicle, and those forces may be translated into a deceleration of a vehicle (e.g., a tractor trailer) based on a mass of the vehicle. In some embodiments, a vehicle may have any number of axles (e.g., if it is hauling two trailers, if it is hauling one trailer, if it is bobtailing). A mapping to a model may be based on a number of axles, in some embodiments. A number of axles may be derived from various signals sent wirelessly, over power line communications (PLC), etc. The number of axles may be determined based on information identifying each trailer, dolly, etc., and/or the number of axles may be determined by messages which do not identify a specific trailer, dolly, etc., such as a Trailer ABS Indicator Lamp OFF (also known as an MID11) message.

In some embodiments, if there is ambiguity (e.g., how many axles are included in a vehicle), a model may error on the side of responding with a hard brake (e.g., a rear vehicle may brake hard in response to a brake applied at a front vehicle when there is ambiguity as to the forces generated at the wheels of a front vehicle, the mass of a front vehicle, and/or deceleration of a front vehicle).

In other words, systems and methods described herein may determine a braking and/or deceleration amount in a front vehicle (e.g., by receiving a wireless signal from a front vehicle), and attempt to substantially (e.g., +/−0.025 g, 0.05 g, 0.1 g) match that amount of braking in a rear vehicle (in some embodiments accounting for mass, wind, or other vehicle attributes described herein). In a hard-braking event, that luxury may not be available (since there may not be enough time), so rather than smooth the braking in a rear vehicle, hard braking is applied. It should be understood that, in some embodiments, at least one middle ground may be available as opposed to the high filtering/smoothing of light braking and low filtering/stiffness of hard braking. For example, at least one “bin” may be available, such that if a brake is pressed ¼, ½, or ¾ between a light brake and a hard brake, an amount of filtering/smoothing may be applied which is not as much as in a light braking event (e.g., ¼), and/or not as little as in a hard braking event (e.g., ¾). In some embodiments, a function may be applied, which may determine what bin a braking event may belong to, or be continuous (or nearly continuous) in nature, and may be achieved, for example, by a polynomial function (e.g., such that the “bins” are very small).

Regarding various attributes which may be taken into account when determining how much braking to apply to a rear vehicle (or other actions described herein), attributes of a front vehicle and/or a rear vehicle may be taken into consideration and used to modify a model. Such attributes may include, but are not limited to a/an: type of vehicle, vehicle class, vehicle position, latitude, longitude, altitude, heading, speed, longitudinal and lateral acceleration, road grade, relative angle to another vehicle, type of load (e.g., type of materials a vehicle is carrying), load (e.g., how a vehicle is loaded and/or where a center of gravity of a vehicle is), a load history (e.g., how a vehicle has been loaded in the past and/or types of loads a vehicle has transported), position in a platoon, historical information of platooning travel, historic driver performance, driver performance, driver behavior, historic driver behavior, turn-by-turn navigation, brake status, brake pressure, brake system, version of a brake system, path history, path projection, travel plans, vehicle size, vehicle type, brake type, current operating mode (autonomous or manual), map data, traffic information, GPS augmentation information (e.g., delays from infrastructure), maximum speed, wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), electric motor, battery, super charger, engine/vehicle component temperature, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, amount of fuel currently being used (e.g., amount of fuel used per amount of time and/or distance), amount of fuel being saved, amount of money being saved by platooning, average amount of money being saved by platooning, historical fuel usage, historical amount of money being saved by platooning, trailer position, current trailer position, past trailer position, tractor type, tractor height, transceiver type, current amount of fuel, previous amount of fuel, vehicle health, next determined/planned stop, projected miles remaining until fuel tanks are empty, malfunctions, turn signals, LIDAR, radar, ultrasonic sensors, road surface, wheel angle, tire pressure, tire tread depth, cabin temperature, engine temperature, trailer interior temperature, camera, fleet of vehicles, NOC that a vehicle can communicate with, computer vision, other vehicle traveling in the same direction, other vehicle traveling in an opposite direction, speed/acceleration/deceleration a vehicle in front of the vehicle is traveling, and intervening traffic (e.g., cut-ins, also referred to as the situation when a vehicle enters an area between a lead vehicle and a rear vehicle causing a dissolve).

In some embodiments, a hard-braking event that is above a certain amount may cause a platoon to dissolve. For example, if a hard-braking event occurs that is greater than a threshold (e.g., 0.3 g), a platoon may dissolve.

It should be understood by one skilled in the art that various sensors may be used to determine attributes associated with a vehicle (as described above)—including various sensors to measure braking—to determine a type of braking event and/or what information to transmit to another vehicle. These sensors may include a treadle valve, a wheel speed monitor, pressure sensors (pneumatic and/or hydraulic), air tank sensors, an internal measurement unit (IMU), etc. Sensor information may be transmitted to a BECU, which may then be transmitted to a platooning ECU (PECU). Of course, sensor information may be transmitted to one or more of a variety of ECUs in response to a system's specific configuration. In some embodiments, ECUs in a front vehicle may be used to observe sensor information, while ECUs in a rear vehicle may be used to actuate vehicle components (e.g., brakes), or vice-versa. For example, gains may be modified in one or more of a rear vehicle's ECUs (e.g., a PECU) to compute a gap (e.g., while taking into account an action to be performed such as smoothing braking).

In some embodiments, which may be used instead of or in combination with other embodiments described herein, a braking event may be measured by a sensor on a rear vehicle, such as radar, LIDAR, etc. For example, in response to receiving a signal indicating light brakes are being applied at a front vehicle, a rear vehicle may use its radar to determine how much to filter/smooth the braking at the rear vehicle while, in some cases, maintaining a desired gap between the vehicles.

In some embodiments, it is contemplated that the systems and methods described herein may apply to a retarder (e.g., a Jake brake) or engine braking. This may occur in combination with foundation brakes. In some embodiments, a signal indicating the use of a retarder or engine in a front vehicle may be filtered/smoothed at a rear vehicle. To assist with smoothing, a PECU, retarder ECU (RECU), engine ECU, (EECU) BECU, and/or a transmission ECU (TECU) may be utilized. For example, a shift in a gear ratio at a rear vehicle may occur at a particular time, in some cases with filtering performed at one or more ECUs, to cause a retarder to be applied at a rear vehicle in as smooth a way as possible. In some embodiments, this may only occur if the estimated amount of smoothness is above a threshold amount.

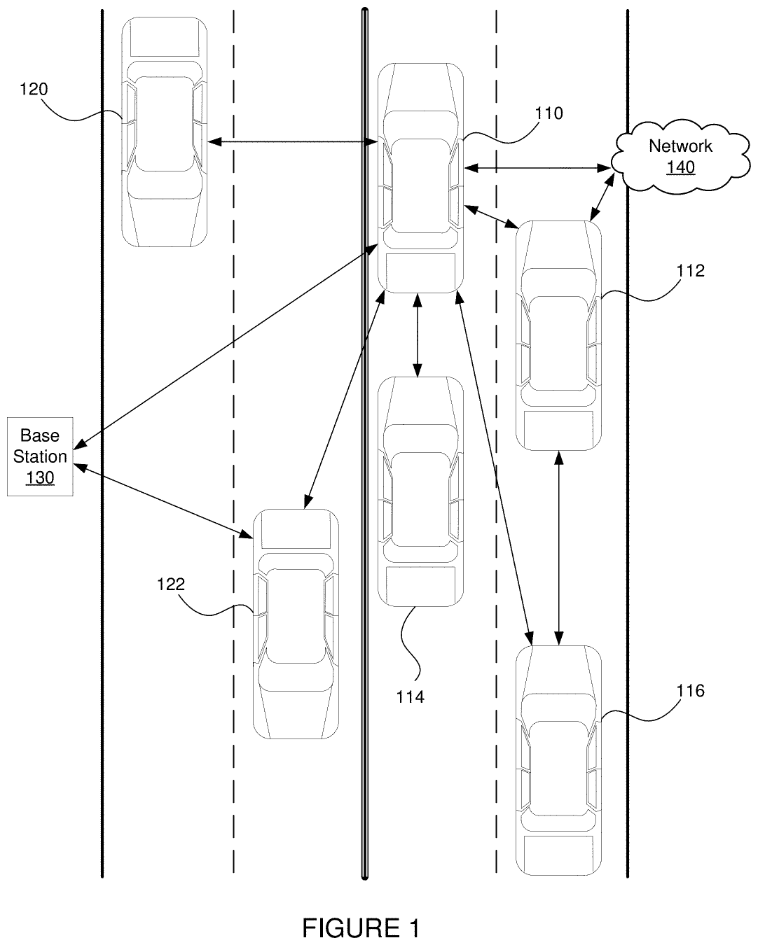

FIG. 1 illustrates a diagram of vehicles transmitting data, in accordance with some embodiments. FIG. 1. depicts multiple vehicles 110, 112, 114, 116, 120, and 122. FIG. 1 also depicts a base station 130 and a network 140. In various embodiments, vehicle 110 may transmit data (also referred to as information) to other vehicles 112, 114, 116, 120, and 122 directly, via base station 130, and/or via network 140. Vehicle 110 may also receive data from other vehicles 112, 114, 116, 120, and 122 directly, via base station 130, and/or via network 140. In some embodiments, a vehicle (e.g., vehicle 112) may retransmit information received from a first vehicle (e.g., vehicle 110) to another vehicle (e.g., vehicle 116) with or without additional information (e.g., information generated at vehicle 112 in addition to information received from vehicle 110).

In various embodiments, vehicles 110, 112, 114, 116, 120, and 122 may be configured to platoon, and may platoon with one another. In some embodiments, vehicles may transmit and/or receive data (e.g., to a NOC and/or fleet management system, etc.) including, but not limited to data indicating: whether they are available to platoon; whether they are platooning; the grade of a road; whether a platoon they were part of dissolved; what direction they are traveling; what direction they are predicted (e.g., predetermined/planning on/suggested) to be traveling on for a particular period of time; when they are expected to stop (e.g., predetermined to stop, planning on stopping, suggested stopping time); where they plan on stopping; what route(s) they plan to travel (e.g., a route suggested and/or determined by a system, a route determined by a navigation/mapping system based on their destination such a system may be a rendezvousing system, a fleet management system, a navigation system, etc.); what type of platooning system they are equipped with; how many hours they have been on the road; weather they are capable of following the leader (e.g., if one or more vehicles can platoon without a driver); whether they are capable of being the leader in a follow-the-leader system; whether the vehicle is fully autonomous (e.g., capable of level 4 according to the SAE classification system); how much fuel they have saved; how much money they have saved; an area they are allowed to travel within; an area they are not allowed to travel outside of; whether they are capable of platooning on city streets; whether they are only capable of platooning on a highway; whether they are capable of platooning on non-public roads; whether they are capable of platooning in a particular construction site, mine, forest, etc.; and whether other attributes associated with a vehicle's account allows them to platoon. As should be understood, one or more of these attributes may be used to determine whether a vehicle can platoon with one or more additional vehicles, and whether a vehicle should platoon with one or more additional vehicles. It is contemplated that in some embodiments, a system may rank one or more vehicles with which a vehicle should platoon. In such an embodiment, if a target vehicle (e.g., a vehicle with a high ranking) that a first vehicle attempts to platoon with platoons with second vehicle before the first vehicle is able to platoon with the target vehicle, then the first vehicle may select another (e.g., the next) ranked vehicle that the system would like it to (e.g., determines that it should attempt to) platoon with.

In addition to these factors, other information that a vehicle may transmit and/or receive may include data including, but not limited to data associated with a/an: type of vehicle, vehicle class, vehicle position, latitude, longitude, altitude, heading, speed, longitudinal and lateral acceleration, relative angle, type of load (e.g., type of materials a vehicle is carrying), load (e.g., how a vehicle is loaded and/or where a center of gravity of a vehicle is), a load history (e.g., how a vehicle has been loaded in the past and/or types of loads a vehicle has transported), position in a platoon, historical information of platooning travel, brake status, brake pressure, brake system, version of a brake system, path history, path projection, travel plans, vehicle size, vehicle type, brake type, current operating mode (autonomous or manual), map data, traffic information, GPS augmentation information (e.g., delays from infrastructure), maximum speed, wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), electric motor, battery, super charger, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, amount of fuel currently being used (e.g., amount of fuel used per amount of time and/or distance), amount of fuel being saved, amount of money being saved by platooning, average amount of money being saved by platooning, historical fuel usage, historical amount of money being saved by platooning, trailer position, current trailer position, past trailer position, tractor type, tractor height, transceiver type, current amount of fuel, previous amount of fuel, vehicle health, next determined/planned stop, projected miles remaining until fuel tanks are empty, malfunctions, turn signals, LIDAR, radar, ultrasonic sensors, road surface, wheel angle, tire pressure, tire tread depth, cabin temperature, engine temperature, trailer interior temperature, camera, fleet of vehicles, NOC that a vehicle can communicate with, computer vision, other vehicle traveling in the same direction, other vehicle traveling in an opposite direction, speed/acceleration/deceleration a vehicle in front of the vehicle is traveling, and intervening traffic (e.g., cut-ins, also referred to as the situation when a vehicle enters an area between a lead vehicle and a rear vehicle causing a dissolve).

It should be understood that, herein, when a system determines that a controller should change the way it operates, that any of these attributes/information/data may be used alone or in combination.

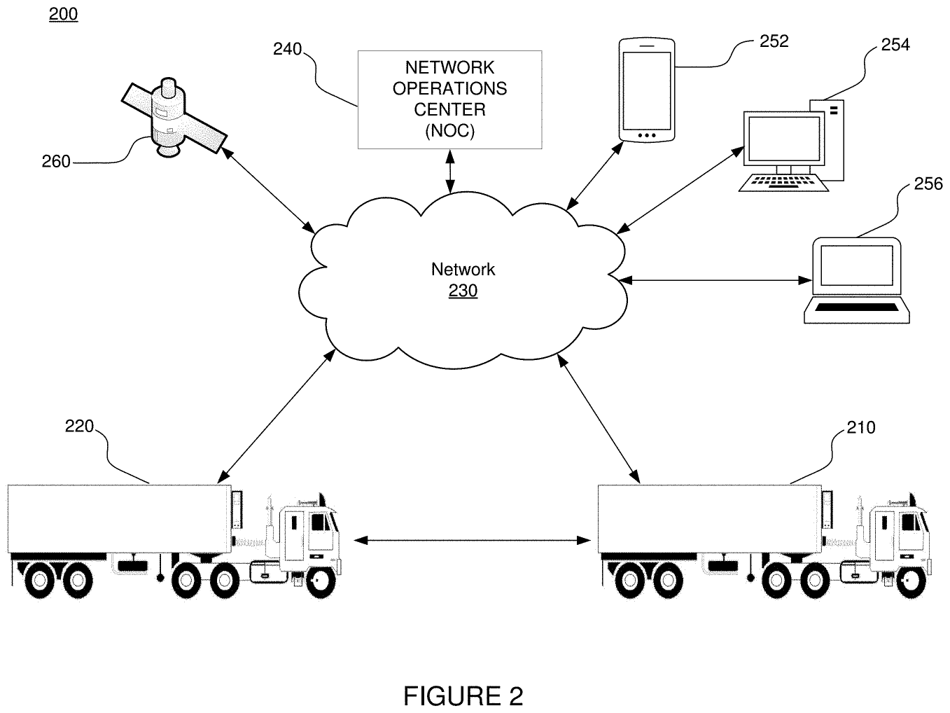

FIG. 2 illustrates an example system 200 including two vehicles capable of platooning and associated communication links. Vehicles 210 and 220 are depicted by trucks which are capable of platooning, and can communicate with each other directly or through network 230. Direct communication between two vehicles can occur wirelessly via Dedicated Short Range Communications (DSRC) (e.g., the IEEE 802.11p protocol), which is a two-way short to medium range wireless communications technology that has been developed for vehicle-to-vehicle (V2V) communications. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee and/or any other now existing or later developed communications channels using any suitable communication protocols either alone or in combination.

FIG. 2 also includes a network operations center (NOC) 240. NOC 240 may include one or more locations from which network monitoring, control, and/or management may be exercised over a communication network (e.g., a NOC may be located in the cloud/a multi-tenant environment). NOC 240 can oversee a complex network of vehicles, satellite communications, web applications, and/or management tools. Users of NOC 240 may be responsible for monitoring one or more networks, sub-networks, fleets of vehicles, and/or sub-fleets of vehicles that may require special attention to avoid degraded service. For example, NOC 240 may receive information about various vehicles 210 and 220 such as their locations and attributes, run various programs based on the received information, and send information back to vehicles 210 and 220, including indicating whether they are allowed to platoon.

In addition to NOC 240, client devices 252 (e.g., a smartphone or tablet), 254 (e.g., a desktop computer or terminal), and 256 (e.g., a laptop computer or terminal) may be used to send and/or receive information about vehicles 210 and 220, NOC 240, or information from canonical sources such as the Internet (e.g., Google Maps or another online map provider, a traffic provider, a weather provider, etc.). Client devices can be used to view attributes of vehicles 210 and 220 such as their location, an estimate of their weight, their speed, an amount of engine torque, amount of applied break, a destination, etc.

FIG. 2 also includes a satellite 260, which can send signals to network 230, NOC 240, and/or vehicles 210 and 220. Satellite 260 may be part of a satellite navigation system such as a global navigation satellite system (GNSS). GNSSs include the United States' Global Positioning System (GPS), Russia's GLONASS, China's BeiDou Navigation Satellite System, and the European Union's Galileo. Based on information sent from satellite 260, systems described herein can determine locations of vehicles 210 and 220.

Of course, it should be appreciated that the system described in FIG. 2 is only an example, and that many other configurations may exist. For example, a NOC may assist with the monitoring and control of hundreds or thousands of vehicles, and many types of web applications may exist.

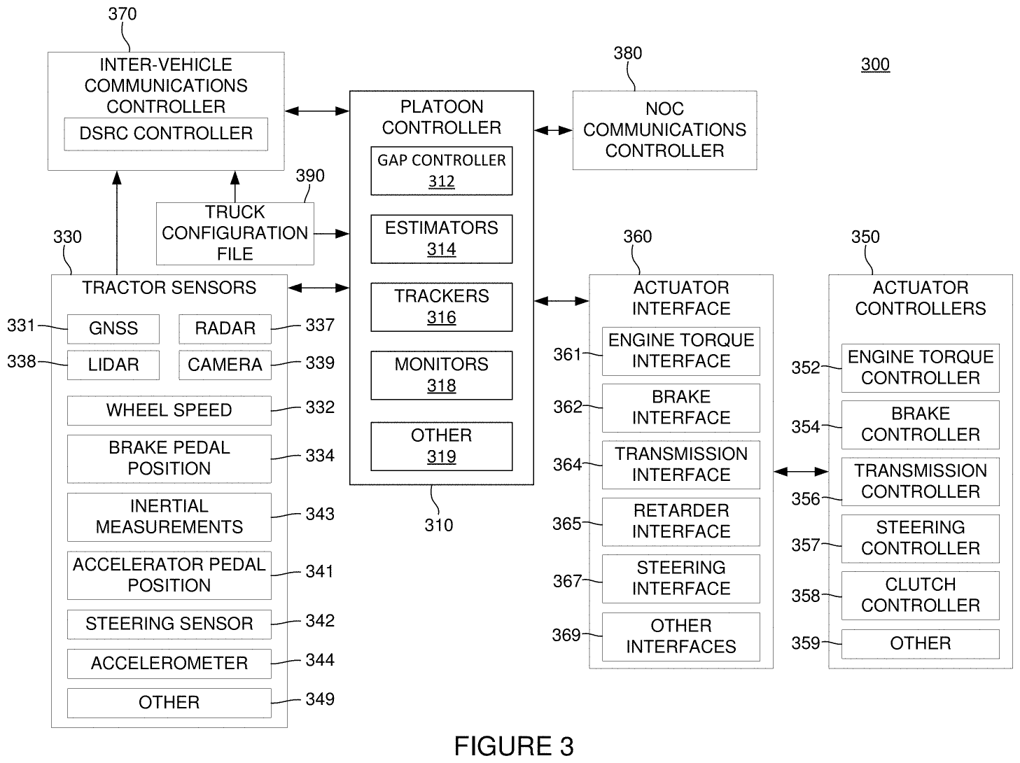

FIG. 3 illustrates and example system 300 including a platoon controller 310 (also referred to as a platoon electronic control unit, a platoon ECU, or a PECU). As described throughout this disclosure, a wide variety of configurations may be used to implement platooning systems described herein. The specific controller design can vary based on the level of automation contemplated for the controller, as well as the nature of and equipment available on the host vehicles participating in the platoon. FIG. 3 illustrates components of one possible configuration.

FIG. 3 diagrammatically illustrates a vehicle control architecture that can be suitable for use with platooning tractor-trailer trucks. The specific controller, or platooning ECU, illustrated is primarily designed for use in conjunction with a platooning system in which both vehicles include an active driver. The driver of the lead vehicle being fully responsible for control of the lead vehicle. In some embodiments the driver of the rear vehicle may be responsible for steering the rear vehicle, but the platoon controller 310 is primarily responsible for controlling the rear vehicle's torque and braking requests during active platooning. However, as discussed herein, it should be appreciated that generally similar control schemes can be used in systems which contemplate more automated control of one or both of the platoon partners or which utilize vehicle control commands other than or in addition to torque and braking requests.

In the example embodiment illustrated in system 300, a platoon controller 310, receives inputs from a number of sensors 330 on the tractor and/or one or more trailers or other connected units, and a number of actuator controllers 350 (also referred to as electronic control units or ECUs) arranged to control operation of the tractor's powertrain and other vehicle systems. An actuator interface 360 may be provided to facilitate communications between the platoon controller 310 and the actuator controllers 350. In some embodiments, one or more of the actuator interfaces 360 may be included in one or more of the actuator controllers 350 (e.g., an actuator interface may be included in an ECU). Platoon controller 310 also interacts with an inter-vehicle communications controller 370 (also referred to as an inter-vehicle communications ECU) which orchestrates communications with the platoon partner and a NOC communications controller 380 (also referred to as a NOC communication ECU) that orchestrates communications with a NOC. The vehicle also may have selected configuration files 390 that include known information about the vehicle.

Some of the functional components of the platoon controller 310 include gap controller 312, a variety of estimators 314, one or more partner vehicle trackers 316 and various monitors 318. In many applications, the platoon controller 310 will include a variety of other components 319 as well.

Some of the sensors utilized by platoon controller 310 may include GNSS unit 331, wheel speed sensors 332, inertial measurement devices 334, radar unit 337, lidar unit 338, cameras 339, accelerator pedal position sensor 341, steering wheel position sensor 342, brake pedal position sensor 343, and various accelerometers 344. Of course, not all of these sensors will be available on all vehicles involved in a platoon and not all of these sensors are required in any particular embodiment. A variety of other sensors 349 (now existing or later developed or commercially deployed) may be additionally or alternatively be utilized by platoon controller 310 in other embodiments.

Many (but not all) of the described sensors, including wheel speed sensors 332, radar unit 337, accelerator pedal position sensor 341, steering wheel position sensor 342, brake pedal position sensor 343, and accelerometer 344 are relatively standard equipment on newer trucks (tractors) used to pull semi-trailers. However, others, such as GNSS unit 331 and lidar unit 338 (if used) are not currently standard equipment on such tractors or may not be present on a particular vehicle and may be installed as needed or desired to help support platooning.

FIG. 3 also illustrates various actuator controllers 350. It should be understood that, in various embodiments, some or all types of controllers may be referred to interchangeably as electronic control units (ECUs). It should, however, be understood that some ECUs may control actuators, some ECUs may control communications, some ECUs may monitor sensors, and some may perform any combination thereof. Thus, it should be appreciated that the system shown in FIG. 3 is merely one of a wide variety of systems that may be used to control platooning.

Some of the vehicle actuator controllers 350 that platoon controller 310 may direct at least in part include engine torque controller 352; brake controller 354; transmission controller 356; steering/automated steering controller 357; and clutch controller 358. Of course, not all of these actuator controllers will be available or are required in any particular embodiment and it may be desirable to interface with a variety of other vehicle actuator controllers 359 that may be available on the vehicle as well. Therefore, it should be appreciated that the specific actuator controllers 350 directed or otherwise utilized by the platoon controller on any particular controlled vehicle may vary widely. Further, the capabilities of any particular actuator controller (e.g. engine torque controller 352), as well as its interface (e.g., the nature and format of the commands, instructions, requests and messages it can handle or generate) will often vary with the make and model of that particular actuator controller. Therefore, an actuator interface 360 is preferably provided to translate requests, commands, messages and instructions from the platoon controller 310 into formats that are appropriate for the specific actuator controller hardware and software utilized on the controlled vehicle. The actuator interface 360 also provides a mechanism for communicating/translating messages, commands, instructions and requests received from the various actuator controllers back to the platoon controller 310. In some embodiments, an appropriate actuator interface may be provided to interact with each of the specific vehicle controllers utilized. In various embodiments, this may include one or more of: an engine torque interface 361; a brake interface 362; a transmission interface 364; a retarder interface 365; a steering interface 367; and/or any other appropriate controller interface 369. In some embodiments, various controllers may be combined (e.g., in the case of a chasses controller, or an engine ECU that also controls a retarder—which may obviate the need for a retarder ECU).

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder may be controlled by the engine torque controller 352 and in such embodiments, the retarder can be controlled by sending appropriate torque commands (which may be negative) to engine torque controller 352. In other embodiments a separate retarder controller (not shown) may be accessible to, and therefore directed by, platoon controller 310 through an appropriate retarder interface 365. In still other embodiments, the platoon controller 310 may separately determine a retarder command that it sends to the actuator interface 360. In such embodiments the actuator interface will interpret the retard command and pass on appropriate retardation control commands to an Engine ECU or other appropriate vehicle controller.

The communications between vehicles may be directed over any suitable channel and may be coordinated by inter-vehicle communications controller 370. As described above, the DSRC protocol may work well.

The specific information transmitted back and forth between the vehicles may vary widely based on the needs of the controllers. In various embodiments, the transmitted information may include the current commands generated by the platoon controller 310 such as requested/commanded engine torque, and/or requested/commanded braking deceleration 382. They may also include steering commands, gear commands, etc. when those aspects are controlled by platoon controller 310. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 310 is also transmitted to the platoon partner and corresponding information is received from the platoon partner so the platoon controllers 310 on each vehicle can develop an accurate model of what the partner vehicle is doing. The same is true for any other relevant information that is provided to platoon controller 310, including any vehicle configuration information 390 that is relevant to platoon controller 310. It should be appreciated that the specific information transmitted may vary widely based on the requirements of platoon controllers 310, the sensors and actuators available on the respective vehicles, and the specific knowledge that each vehicle may have about itself.

The information transmitted between vehicles may also include information/data about intended future actions as will be discussed in greater detail below. For example, if the lead vehicle knows it is approaching a hill, it may expect to increase its torque request (or decrease its torque request in the context of a downhill) in the near future and that information can be conveyed to a rear vehicle for use as appropriate by the platoon controller 310. Of course, there is a wide variety of other information that can be used to foresee future torque or braking requests and that information can be conveyed in a variety of different forms. In some embodiments, the nature of the expected events themselves can be indicated (e.g., a hill, curve, or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as a cellular network, various Wi-Fi networks, DSRC networks, satellite communications networks and/or any of a variety of other networks as appropriate. The communications with the NOC may be coordinated by NOC communications controller 380. The information transmitted to and/or received from the NOC may vary widely based on the overall system design. In some circumstances, the NOC may provide specific control parameters such as a target gap. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to platoon controller 310. The NOC may also provide information about the partner vehicle including its configuration information and any known relevant information about its current operational state such as weight, trailer length, etc.

Lastly, with regard to FIG. 3, configuration file 390 may include a wide variety of information about the host vehicle that may be considered relevant to controller 310. By way of example, some of the information might include the vehicle's specification including such things as engine performance characteristics, available sensors, the existence and/or type of platooning indicators (e.g., lights that indicate a vehicle is platooning), the nature of its braking system, the location of its GNSS antenna relative to the front of the cab, gear ratios, differential ratios etc. In some embodiments, configuration file 390 may include information about a driver, a fleet, a fleet's schedule, a driver rating, a driver's ability to use the system, whether a vehicle has permission to use a system, whether a vehicle is certified to use the system, etc.

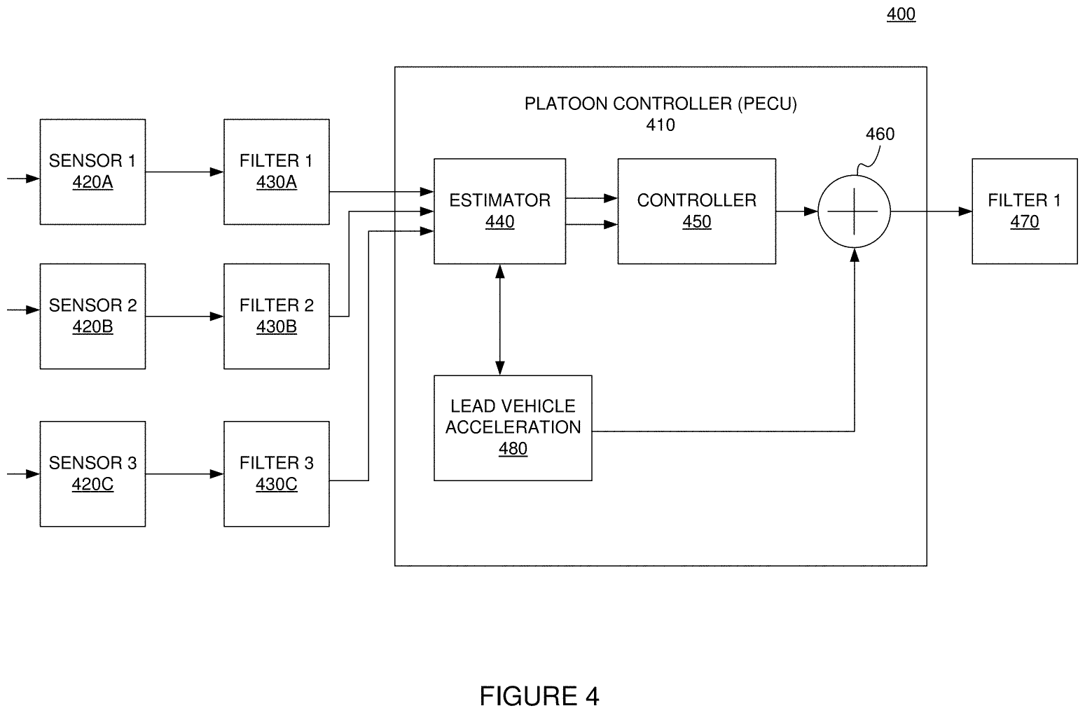

FIG. 4 illustrates an example system 400 including a PECU 410. FIG. 4 includes sensors 420A, 420B, and 420C. FIG. 4 also includes filters 430A, 430B, and 430C. It should be understood by one skilled in the art that all, some, or none of these sensors and filters may be implemented in systems and methods described herein. FIG. 4 includes a PECU 410, which may include an estimator 440, a controller 450, an arithmetic unit 460, and a module 480 which may determine a lead vehicle's acceleration. (Of course, even though not shown in FIG. 4, in some embodiments a module that determines a lead vehicle's acceleration may be an estimator). Each of the units included in PECU may include a filter and/or may change gain values (furthermore, so may the filters outside of PECU 410 in some embodiments). FIG. 4 also includes a filter 470, which may filter outputs from PECU 410.

In some embodiments, PECU 410 may be included in a front vehicle, a rear vehicle, or in both. In various embodiments, a vehicle may receive information from a sensor and/or transmission from another vehicle, filter that information at filters 430A, 430B, 430C, estimator 440, controller 450, and/or filter 470 (for example, to produce a smoother ride/braking event). PECU 410 may also receive information corresponding to a front vehicle's acceleration (e.g., at module 480). This information may be received from a transmission from a front vehicle, from a sensor such as a radar or LIDAR (herein, radar, LIDAR, ultrasonic sensors, and the like, may be referred to as distance sensors since at least a portion of their output is a distance between an object and the sensor), etc. In some embodiments, module 480 and/or arithmetic unit 460 may determine that a front vehicle is braking hard, and that a hard brake should be applied at a rear vehicle. In some embodiments, if a hard brake at a front vehicle is not detected, a rear vehicle may not brake hard, and instead receive signals from sensors 420A, 420B, and 420C, for example, filter those signals if need be to produce a smoother ride for a driver of a rear vehicle, and pass that information through estimator 440, controller 450, and/or arithmetic unit 460. In such an embodiment, information included in signals from module 480 may not be weighted as heavily. In other words, in some embodiments, based on conditions (e.g., a breaking amount of a first vehicle), and electronic control unity (e.g., a PECU) may be adjusted to place more weight on a first input (e.g., an input from controller 450) than a second input (e.g., lead vehicle acceleration 480), or be adjusted to place more weight on a second input than a first input. When referring to whether more weight is given to one input or another, it should be understood that a weight may be an amount multiplied by a constant (e.g., if input from a controller is meant to cause a PECU to cause light brake and input from a lead vehicle acceleration module is meant to cause a PECU to cause a hard brake, then a weighting may make an arithmetic unit of a PECU to cause 100% of a signal from a controller to go to the arithmetic unit while 0% of a signal from a lead vehicle acceleration module to go to the arithmetic unit (or at least be considered in any equation), or some other combination may be implied by weighting such as 25% and 75%, 50% and 50%, 10% and 90%, 150% and 50%, etc. Of course, it will be readily apparent to one skilled in the art that while these functions are being performed, the same, additional, or fewer components may be utilized to maintain a gap between a front vehicle and a rear vehicle. Further, an arithmetic unit is used herein as an example component/means of combining signals, calculating an output of a controller (e.g., a PECU), and/or applying weights to inputs, and it may not be included in all controllers. In some embodiments, a component other than an arithmetic unit 460 may be used to apply weights to various signals/inputs.

In some embodiments, a controller at a high level operates by adding a “feed-forwards” and “feedback” terms. The feed-forwards term may operate by adding the front vehicle's acceleration (which may be estimated from accelerometers, reported engine/retarder torque, reported brake pedal, estimated wind drag, estimated rolling resistance, gravity, etc.) to the rear vehicle's acceleration if it were to coast (calculated from wind drag, rolling resistance, gravity, etc.) to determine how much engine/retarder torque a rear vehicle may need to substantially match the front vehicle's acceleration. A feedback term is a term that estimates and/or determines the current gap (and/or target gap) and/or velocity estimates to determine that a rear vehicle should increase or decrease its acceleration relative to the front vehicle in order to maintain the gap.

In various embodiments a lead vehicle acceleration module 480 may be an estimator such as estimator 440, or it may transfer information to and/or from an estimator. Of course, it should be understood that the system shown in FIG. 4 is an example, and any of the various elements/components/modules shown in FIG. 4 may be added, removed, not included within a controller, included in a different module, communicate with some, all, or none of the other elements/components/modules shown in FIG. 4. (Of course, this may be the case for any systems shown herein).

As discussed above, controller gains may be adjusted to be higher or lower based on events described herein. For example, feedback gains may be adjusted if a gap is not at a desired distance/headway. A controller/gains may be made stiffer or looser, wherein a gain that is more loose will allow a vehicle to have more freedom (e.g., allow a gap to be maintained less strictly) and a stiffer gain may cause a vehicle to attempt to maintain a gap more precisely. In some embodiments, a looser gap may cause a rear vehicle to operate more smoothly before it corrects a gap, which may cause more gap encroachment than a stiffer controller. In some embodiments, a stiffer gap may cause a rear vehicle to be less smooth, and in some cases may cause a vehicle to overcorrect in response to an undesired gap.

In various embodiments, gain scheduling may be performed with estimator 440. For example, estimator 440 may receive information from sensors 420A, 420B, and 420C which may assist in determining a gap. Radar and/or LIDAR may be used in some embodiments. In some embodiments, for steady state platooning a radar may interject noise into a controller and decrease fuel economy, so in various methods and systems described herein, a radar and/or LIDAR signal may be fused with other models that can be used to determine how a gap should be changing (e.g., based on information about a front and/or rear truck). In other words, noise from a radar may be rejected in some instances.

In some embodiments, it may not be desirable to reject noise, such as in a hard-braking event. This may be because a front vehicle may be surging toward a rear vehicle. In such a case, the way in which sensors are fused may be changed, and a model that a gap is based on may be chosen based on whether a system determines a front vehicle is braking or not. Thus, as described herein, when a controller is determining how much braking to apply at a rear vehicle it will base its decision on a detected distance from a front vehicle by a radar, a velocity, wireless transmissions including an amount of braking applied at a front vehicle, wheel speeds of a front vehicle, wheel speeds of a rear vehicle, an amount of axles on a front vehicle, and amount of axles on a rear vehicle, and/or other vehicle attributes as described above.

In various embodiments systems and methods herein can be described as happening in two stages. First, sensors and ECUs may determine a gap between a front vehicle and a rear vehicle and the relative velocities of each. This information may inform a feedback controller. Braking in a front vehicle may be used in a feed forward controller, and may be added to the information from the feedback controller to produce a command (e.g., to a braking system). Second, in addition to determining what the gap and relative velocity are (e.g., at estimator 440), in response to whether a rear vehicle is braking or not, a determination will be made (e.g., at controller 450). Specifically, if a rear vehicle is currently braking, the rear vehicle may rely more heavily on radar to determine a gap, while when a vehicle is not braking a radar signal may be relied upon less or rejected all together. Thus, sensor fusion gains may change based on whether a vehicle is braking or not. Further, feed forward scaling and filtering adjustments may be made by a controller based on an amount of braking applied. Further still, cut-ins may cause a controller to make additional adjustments based on how close a vehicle is to the cut-in vehicle.

As such, in various embodiments, as a rear vehicle is attempting to move away from a front vehicle, for smooth dissolves a controller may apply low gains and not overreact, but with a cut-in a controller may be configured to be stiffer and respond more quickly. In such a case, a controller may be up-tuned. In various embodiments, systems and methods as described herein may be tuned to react quickly. In some cases, if estimator 440 is slow to respond but controller 450 is not slow to respond, then a system may be slow overall. In some cases, if controller 450 is slow to respond but estimator 440 is not slow to respond, then a system may still be slow overall. Thus, the combination of the tuning of estimator 440 and controller 450 may be tuned to produce optimal performance (e.g., a low/least amount of latency). Further, it is contemplated that in some embodiments estimator 440 and controller 450 may be combined as one module/unit/component. Moreover, in some embodiments, machine learning (e.g., a neural network) may be implemented to determine an amount of tuning in various components discussed herein such as estimator 440 and/or controller 450. It should be appreciated that in some embodiments, one or more filters receive data from estimator 440 and provide data to controller 450.

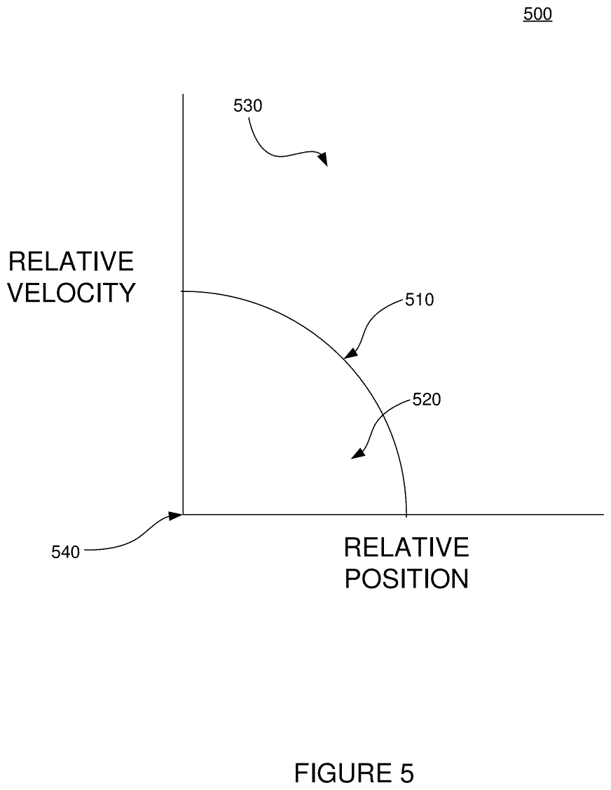

FIG. 5 illustrates an example graph 500, in accordance with some embodiments. Graph 500 includes a Y axis indicating a relative velocity between two vehicles, and an X axis indicating a relative position between those two vehicles. Graph 500 includes a semicircle 510 indicating an area 520 within which the two vehicles are operating properly (e.g., their relative velocity and position are within an acceptable range), and an area 530 at which the two vehicles are not operating properly (e.g., their relative velocity and position are outside of an acceptable range). Of course, it is contemplated that more than two vehicles may be included in a platoon, and in some cases may be represented by a similar graph and/or operated using a controller in a fashion the same as, or similar to, those as described above.

At point 540 (e.g., 0, 0), both a relative velocity and a relative position between two vehicles is 0. When platooning vehicles are in this state, they may be considered as being in a steady state. That is to say, they may be traveling at the same speed, and maintaining the same distance between one another. In some cases, if the relative velocity increases above a threshold, the relative position increases above a threshold, and/or a combination of the two increase above a threshold (e.g., enter area 530), then a platoon may dissolve (and in some cases increase a gap aggressively/quickly). Further, the controller may determine that it wants a vehicle to travel even further away from 0, 0 in response to various conditions (which may also be referred to as events) and/or vehicle attributes such as those above, including rain, a hard stop, a collision, etc. In some embodiments, when the vehicles are traveling such that they are within semicircle 510 a controller may operate using greater filtering, without causing hard braking at the rear vehicle.

Within the scope of this disclosure, it should be understood that various controllers (or other devices, such as an estimator) may be tuned/gain may be adjusted/an amount of filtering may be adjusted to control vehicle attributes in addition to, other than, or in combination with an amount of braking applied. As mentioned above, a controller may adjust an amount of filtering/gain to cause stiffer or looser steering based on a variety of factors such as those mentioned above, and/or a width of a lane and/or speed of a vehicle.

In some embodiments, gains/filters may be adjusted based on whether a vehicle is in a construction zone, such that the vehicle cannot speed up, slow down, or change lanes as easily. Other conditions may cause changes in a controller such as whether there is liquid on a roadway, windshield wipers are on, an amount of traffic, a location, etc.

In some embodiments herein, such as in the following paragraphs, a system may refer to one or more of a V2X system, V2V system, a platooning system, a brake system, a battery management system, a NOC communicatively coupled to one or more vehicles (e.g., a front and/or rear vehicle if one or more of the vehicles are configured to be able to platoon (e.g., be a platoonable vehicle)), etc. Of course, some of these systems/terms may overlap (e.g., a V2X system may include a V2V system, a V2V system may include a platooning system, a platooning system may include a brake system and/or battery management system, etc.)

In some embodiments, based on the current signal reliability between the front and rear vehicles, a system may adjust the weighting of the radar and other directly measured signals, because of the increased risk of receiving inaccurate or delayed information from the front vehicle, which may be a car, truck, or other vehicle.

In some embodiments, based on reported faults from ECUs in a first vehicle and/or a second vehicle, a system may adjust a gap and/or controller gains.

In some embodiments, based on recent driver behavior (e.g., steering wheel motion) or recent driver state (e.g., as determined by a driver monitoring system), a system may adjust a gap and/or controller gains.

In some embodiments, based on the current and upcoming grade of the road, a system may adjust the gains in the controller, in order to better handle expected scenarios (e.g., on a downhill you are not using the engine, and so you do not necessarily gain fuel economy benefits (although there are some subtleties there) from platooning, and so you may be less aggressive about keeping the gap as small as allowable).

In some embodiments, based on sensor signal quality (e.g., the precision of a GPS fix, the noise in radar targets), a system may adjust both the weighting of the signals as well as the overall controller gains, because the system may need to provide more or less buffer against unexpected scenarios when the sensors are not providing as reliable of signals.

In some embodiments, based on the current or upcoming traffic (which could be communicated to the vehicles from the cloud, or estimated locally based on truck speed, frequency of vehicle cut-ins, or even cameras mounted on the vehicles), a system may adjust the gap and the controller gains, because, depending on exact traffic scenarios: A system may determine that a shorter gap should be in place/created/determined where reasonable to reduce the odds of vehicle cut-ins (or may want a larger gap to make the vehicle cut-ins that do happen safer); higher traffic may imply higher variance in front vehicle speed, and so a rear vehicle controller may attempt to smooth out the speed fluctuations with smoother (typically, lower) gains than when the front vehicle can be expected to maintain a constant speed (e.g., for miles at a time).

In some embodiments, based on the headway between the front vehicle and the closest vehicle in front of it (possibly taking into account lane information, where the front vehicle may detect vehicles in front of it in neighboring lanes), a system may adjust the gap or controller gains in order to account for the uncertainty introduced by the vehicle preceding the front vehicle (e.g., were it to slow down unexpectedly, change lanes to in front of the front vehicle, etc.).

In some embodiments, a system may:

adjust an attribute of a platooning system, use one or more different/switch to one or more different controllers to change the operation of a vehicle (e.g., platooning) system (e.g., switching from a controller designed specifically for fuel economy to one for safety, or using a controller which requires more computational time when not engaging in a hard braking event, while using a simpler but more reliable/faster controller under hard braking events), adjust a gap, adjust a desired gap, adjust a speed of a vehicle, adjust a route, adjust a vehicle path, adjust an acceleration, adjust the weighting of the radar and other directly measured signals, authorize or deauthorize a platoon from occurring, dissolve a platoon, cause a platoon to form, cause a safety mechanism to be deployed, cause a light (e.g., a turn signal, a brake light, a warning light, a on a dashboard) to turn on or off, cause information to be displayed on a dashboard and/or HUD, choose a playlist including audio and/or video, suggest a playlist including one or more videos and/or songs, suggest/choose a video game and/or portion thereof (e.g., for a passenger in a vehicle to play), command the torque of a vehicle, control a torque of a vehicle, steer a vehicle, gather information (e.g., location information, video/images) about another vehicle and/or transmit the information gathered about another vehicle to that vehicle, cause a temperature of a component in a vehicle to change, cause a noise to sound within and/or external to a vehicle, change an amount of gain, add or remove a filter (e.g., of signals transmitted to components (e.g., components shown in FIGS. 1, 2, 3, 4, and/or 7, brakes, an engine, a transmission)), adjust a component (e.g., components shown in FIGS. 1, 2, 3, 4, and/or 7, brakes, an engine, a transmission)), cause a camera to start recording, cause a vehicle to transmit and/or receive information to/from a new source (e.g., a base station, a street light, another vehicle, a charging station), cause a video and/or photo to be saved and/or transmitted (e.g., videos stored in a buffer may be stored elsewhere, such as in non-volatile memory), cause a vehicle to stop, and/or other events mentioned herein,

based on one or more of: an amount of brake, whether a hard braking event is occurring or occurred, whether a soft braking event is occurring or occurred, information provided by a machine learning system, whether a cutin occurred, a current or previous gap between vehicles, whether a collision occurred, whether a collision almost occurred (which may be determined based on a sensor reading, information captured by a camera, a speed of a vehicle), attributes of a driver or passenger (e.g., an amount of attention a driver or passenger is paying attention based on information received by a camera), and/or data associated with a/an: rendezvous location, projected rendezvous location, type of vehicle, vehicle class, vehicle position, latitude, longitude, altitude, heading, speed, longitudinal and lateral acceleration, relative angle, type of load (e.g., type of materials a vehicle is carrying), load (e.g., how a vehicle is loaded and/or where a center of gravity of a vehicle is), a load history (e.g., how a vehicle has been loaded in the past and/or types of loads a vehicle has transported), position in a platoon, historical information of platooning travel, brake status, brake pressure, brake system, version of a brake system, a road, a grade of a road, grades of two or more roads, grades of two or more portions of a road, path history, path projection, travel plans, vehicle size, vehicle type, brake type, current operating mode (autonomous or manual), map data, traffic information, GPS augmentation information (e.g., delays from infrastructure), maximum speed, wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), electric motor, battery, super charger, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, amount of fuel currently being used (e.g., amount of fuel used per amount of time and/or distance), amount of fuel being saved, amount of money being saved by platooning, average amount of money being saved by platooning, historical fuel usage, historical amount of money being saved by platooning, trailer position, current trailer position, past trailer position, tractor type, tractor height, transceiver type, current amount of fuel, previous amount of fuel, vehicle health, next determined/planned stop, an amount of estimated time remaining in a trip, a video game, an amount of time/estimated time remaining in at least a portion of a multi-player video game, a video and/or audio playlist, an amount of time/estimated time remaining in a video and/or audio playlist, an audio book, an amount of time remaining in an audio book, projected miles remaining until fuel tanks are empty, malfunctions, turn signals, LIDAR, radar, ultrasonic sensors, road surface, wheel angle, tire pressure, tire tread depth, cabin temperature, engine temperature, trailer interior temperature, camera, fleet of vehicles, NOC that a vehicle can communicate with, computer vision, other vehicle traveling in the same direction, other vehicle traveling in an opposite direction, speed/acceleration/deceleration a vehicle in front of the vehicle is traveling, and intervening traffic (e.g., cut-ins, also referred to as the situation when a vehicle enters an area between a lead vehicle and a rear vehicle causing a dissolve). A system may perform any of the events in real- or near-real time. Also, a system may perform more, or less, of any of the events (e.g., place more or less weight on an event) described herein (e.g., above) based on one or more attribute (e.g., the attributes (including everything named/described after the phrase “based on:”, above).

In some embodiments, information such as: a distance to a target (e.g., a vehicle), an angle relative to a target, a speed relative to a target, fuel economy, internal faults in an automation system, internal faults in a vehicle other than internal faults in an automation system, sensed and/or predicted upcoming and/or current vehicle grades, environmental conditions, traffic, current and/or upcoming actions by a first vehicle and/or a second vehicle, communication link status (e.g., V2V, V2Cloud, V2X), latency of a communication link, bandwidth of a communication link, signal to noise ratio of a communication link, signal strength of a communication link, corrupted packet rate associated with a communication link, dropped packet rate associated with a communication link, driver awareness measurement(s), driver voice communication use, engine speed, coolant temperature, and/or other powertrain data, can cause an action to occur such as those listed above in this application, when the information is above or below a threshold amount, when the information is above or below a threshold amount when a moving average and/or other smoothing function is applied to the information, and/or when a weighted combination of values corresponding to the various information is above or below a threshold amount, when the information is optimized (e.g., by an algorithm such as a machine learning algorithm), or other attributes of the information.

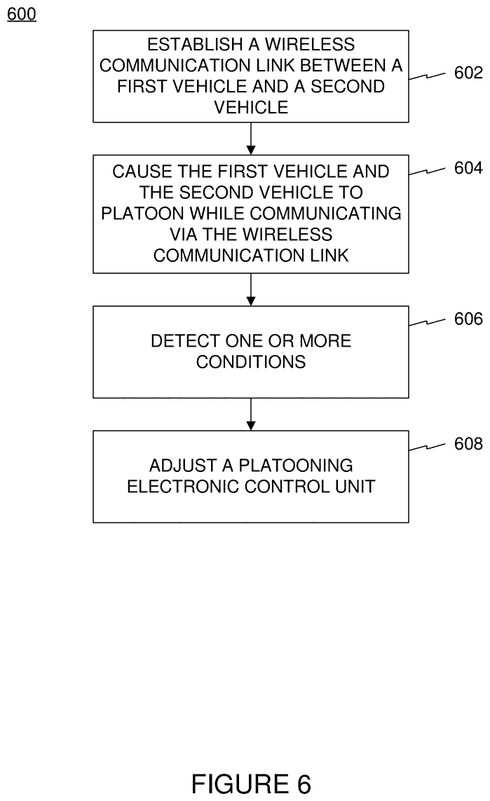

FIG. 6 illustrates a flowchart of an example process, in accordance with some embodiments. Example process 600 includes a method for determining a time for a platoonable vehicle to travel on one or more roads, in accordance with various embodiments. While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 6 should not be construed as limiting the scope of the invention. In one or more embodiments, the steps of FIG. 6 can be performed by example systems 100, 200, 300, and/or computing system 700.

In step 602, a wireless communication link is established between a first vehicle and a second vehicle. For example, two vehicles may begin communicating with each other over a DSRC link.

In step 604, the first vehicle and the second vehicle platoon while communicating via the wireless link. For example, the first vehicle and the second vehicle may transmit information associated with vehicle attributes, as discussed above, including an amount of brake applied at a first (e.g., front) vehicle.

In step 606, one or more conditions (which be refer to an event) are detected. For example, a condition such as a hard brake at the first vehicle may be detected. Various conditions detected may be transmitted to another vehicle. Conditions may include a vehicle attribute as described above, including an amount of brake applied at a first (e.g., front) vehicle. Conditions may be above or below a threshold. For example, an amount of brake applied may be above or below a threshold, and a PECU may be adjusted based on whether the amount of brake is above or below the threshold.

In step 608, a platoon electronic control unit is adjusted. For example, a PECU may be adjusted such that a module that is intended to provide a signal indicating that a vehicle should perform a hard brake may receive additional weight. In some embodiments, a PECU may be adjusted such that a module that is intended to provide a signal indicating that a vehicle should perform a light brake may receive additional weight. In some embodiments, based on a condition the signal indicating that a vehicle should perform a hard brake may receive more weight than the signal indicating that a vehicle should perform a light brake, or vice-versa.

Of course, the steps described in flowchart 600 may be applied to conditions other than braking, as explained throughout the instant disclosure.

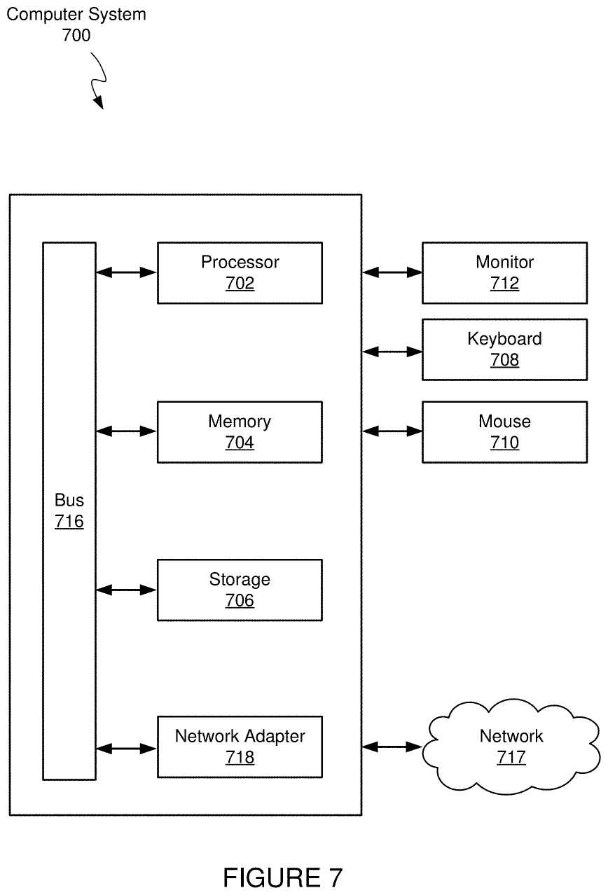

FIG. 7 illustrates an example computing system 700, in accordance with some embodiments.

In various embodiments, the calculations performed above may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

This disclosure contains numerous references to a NOC and to one or more processors. According to various aspects, each of these items may include various kinds of memory, including non-volatile memory, to store one or more programs containing instructions for performing various aspects disclosed herein.

For example, as shown in FIG. 7, example computing system 700 may include one or more computer processor(s) 702, associated memory 704 (e.g., random access memory (RAM), cache memory, flash memory, read only memory (ROM), electrically erasable programmable ROM (EEPROM), or any other medium that can be used to store the desired information and that can be accessed to retrieve that information, etc.), one or more storage device(s) 706 (e.g., a hard disk, a magnetic storage medium, an optical drive such as a compact disk (CD) drive or digital versatile disk (DVD) drive, a flash memory stick, etc.), and numerous other elements and functionalities. The computer processor(s) 702 may be an integrated circuit for processing instructions. For example, the computer processor(s) may be one or more cores or micro-cores of a processor. The computing system 700 may also include one or more input device(s) 710, such as a touchscreen, keyboard, mouse, microphone, touchpad, electronic pen, or any other type of input device. Further, the computing system 700 may include one or more output device(s) 708, such as a screen (e.g., a liquid crystal display (LCD), a plasma display, touchscreen, cathode ray tube (CRT) monitor, projector, or other display device), a printer, external storage, a speaker, or any other output device. The computing system 700 may be connected to a network 714 (e.g., a local area network (LAN), a wide area network (WAN) such as the Internet, mobile network, or any other type of network) via a network interface connection 718. The input and output device(s) may be locally or remotely connected (e.g., via the network 712) to the computer processor(s) 702, memory 704, and storage device(s) 706.

One or more elements of the aforementioned computing system 700 may be located at a remote location and connected to the other elements over a network 714. Further, embodiments of the invention may be implemented on a distributed system having a plurality of nodes, where each portion of the invention may be located on a subset of nodes within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet (e.g., the NOC). These cloud-based services (e.g., software as a service, platform as a service, infrastructure as a service, etc.) may be accessible through a Web browser or other remote interface.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment.

While this disclosure has been described in terms of several aspects, there are alterations, modifications, permutations, and equivalents which fall within the scope of this disclosure. In view of the many alternative ways of implementing the methods and apparatuses of the present disclosure, it is intended that the following appended claims be interpreted to include all such alterations, modifications, permutations, and substitute equivalents as falling within the true scope of the present disclosure.

What is claimed is:

1. A method for managing at least partially automated vehicles comprising:
establishing a wireless communication link between a first vehicle and a second vehicle, wherein the first vehicle and the second vehicle are at least partially automated and communicate via the wireless communication link;
detecting, at one or more sensors on the first vehicle and/or second vehicle, one or more conditions; and
adjusting an electronic control unit, based on the detected one or more conditions, to place more weight on a first input than a second input or more weight on the second input than the first input.

2. The method of claim 1, wherein the one or more conditions comprise an amount of brake applied at the first vehicle, wherein placing more weight on the first input than the second input causes the second vehicle to brake hard, and wherein placing more weight on the second input than the first input causes the second vehicle to brake in response to information received from a distance sensor.

3. The method of claim 2, wherein the at least partially automated vehicles are capable of platooning.

4. The method of claim 1, wherein the detected one or more conditions include an amount of brake applied at the first vehicle.

5. The method of claim 4, wherein the amount of brake applied at the first vehicle is either a hard brake or a light brake.

6. The method of claim 4, wherein placing more weight on the first input causes the second vehicle to perform a hard brake, and wherein placing more weight on the second input causes the second vehicle to perform a light brake.

7. The method of claim 6, wherein performing a light brake comprises filtering one or more signals received from one or more sensors to reduce fluctuations in braking.

8. The method of claim 6, wherein performing a light brake comprises filtering one or more signals at an estimator included in the electronic control unit.

9. The method of claim 4, wherein a filter is applied at the electronic control unit in response to the amount of brake applied at the front vehicle being less than a threshold amount.

10. The method of claim 4, wherein an amount of brake applied at the second vehicle is based at least in part on a mass of either the first vehicle or the second vehicle, and the weights placed on the first and second inputs.

11. The method of claim 4, wherein the amount of brake applied at the second vehicle is based at least in part on whether the weight placed on the first input is greater than the weight placed on the second input or the weight placed on the second input is greater than the weight placed on the first input.

12. The method of claim 1, further comprising:
receiving information from a radar located at the second vehicle; and
applying an amount of brake at the second vehicle based the received information from the radar, wherein the detected one or more conditions includes an estimated amount of brake applied at the first vehicle, and wherein the estimated amount of brake applied at the first vehicle is estimated based on the received information from the radar.

13. The method of claim 1, wherein the detected one or more conditions include an amount of brake applied at the first vehicle, and wherein the first input instructs the electronic control unit to cause the second vehicle to perform a hard brake and the second input instructs the electronic control unit to cause the second vehicle to perform a light brake.

14. The method of claim 5, wherein the hard brake corresponds to an amount of brake pressure or an amount of deceleration, and/or wherein the light brake corresponds to the amount of brake pressure or the amount of deceleration.

15. The method of claim 8, wherein the estimator includes a filter.

16. The method of claim 3, wherein the adjusting the PECU occurs at the first and/or second vehicle.

17. A system for managing a convoy of vehicles, the system comprising:
a processor;
memory; and
one or more instructions configured to cause the processor to cause a platooning electronic control unity (PECU) included in a rear vehicle to:
receive a transmission from a front vehicle, wherein the transmission includes a detected condition; and
configure a controller within the PECU to perform in one of a plurality of ways based on the detected condition.

18. The system of claim 17, wherein the condition includes an amount of brake applied at the front vehicle.

19. The system of claim 18, wherein the controller is configured to apply a hard brake at the rear vehicle in response to the amount of brake applied at the front vehicle being above a threshold amount.

20. The system of claim 19, wherein the controller is further configured to apply a light brake at the rear vehicle in response to the amount of brake applied at the front vehicle being below a threshold amount.

21. The system of claim 20, wherein one or more signals indicating an amount of brake applied at the front vehicle are filtered in response to a determination that the amount of brake applied at the front vehicle is below the threshold amount.

22. A method for managing a platoon of vehicles comprising:
receiving, at controller included in a rear vehicle, information about an amount of brake applied at a front vehicle;
in response to the amount of brake applied at the front vehicle being above a threshold, causing a controller to weight signals, received from a first module, intended to cause a hard brake more than signals, received from a second module, intended to cause a light brake.

23. The method of claim 22, further comprising:
in response to the amount of brake applied at the front vehicle being below the threshold, causing the controller to weight the signals, received from the second module, intended to cause the light brake more than the signals, received from the first module, intended to cause the hard brake.

24. The method of claim 23, wherein the signals, received from the second module, intended to cause the light brake are smoothed using one or more filters.

25. A method for managing platoonable vehicles comprising:
establishing a wireless communication link between a first vehicle and a second vehicle;
causing the first vehicle and the second vehicle to platoon while communicating via the wireless communication link;
detecting, at one or more sensors on (1) the first vehicle, (2) the second vehicle, or (3) both vehicles, one or more conditions while platooning; and
adjusting a platoon electronic control unit (PECU) to change a relationship between one or more data inputs and one or more actuators.

26. The method of claim 25, wherein adjusting the PECU to change a relationship between one or more data inputs and one or more actuators comprises adjusting the PECU to place more weight on data received from first input than data received from a second input.
